(19) United States
(12) Patent Application Publication
(10) Pub. No.: US 2016/0361897 A1
(43) Pub. Date: Dec. 15, 2016

(54) Systems and Methods for Implementing Robust Metallic Glass-Based Fiber Metal Laminates

(71) Applicant: California Institute of Technology, Pasadena, CA (US)

(72) Inventors: Douglas C. Hofmann, Altadena, CA (US); John Paul C. Borgonia, Santa Fe Springs, CA (US); Gregory S. Agnes, Valencia, CA (US); Samuel C. Bradford, Pasadena, CA (US); Eric Oakes, Pasadena, CA (US); Kristina Rojdev, Pasadena, CA (US); Steve Nutt, Pasadena, CA (US); Lee Hamill, Pasadena, CA (US)

(73) Assignee: California Institute of Technology

(21) Appl. No.: 14/660,730

(22) Filed: Mar. 17, 2015

Related U.S. Application Data
(60) Provisional application No. 61/954,347, filed on Mar. 17, 2014.

(51) Int. Cl. B32B 15/14; B32B 17/06

(52) U.S. Cl. CPC B32B 15/14; B32B 17/06; B32B 2262/101; B32B 2571/00

(57) ABSTRACT

Systems and methods in accordance with embodiments of the invention implement robust metallic glass-based fiber metal laminates. In one embodiment, a robust metallic glass-based fiber metal laminate includes: a first layer including a fiber-reinforced composite material; and a second layer including a metallic glass-based material; where the metallic glass-based material is based on at least one non-ferromagnetic element.

### CROSS-REFERENCE TO RELATED APPLICATIONS

The current application claims priority to U.S. Provisional Application No. 61/954,347, filed Mar. 17, 2014, the disclosure of which is incorporated herein by reference.

### STATEMENT OF FEDERAL FUNDING

The invention described herein was made in the performance of work under a NASA contract, and is subject to the provisions of Public Law 96-517 (35 U.S.C. §202) in which the Contractor has elected to retain title.

### FIELD OF THE INVENTION

The present invention generally relates to fiber metal laminates.

### BACKGROUND

Fiber metal laminates (“FMLs”) are relatively new composite materials typically characterized by interlaced layers of metals and fiber reinforced composite materials. Amongst the most commercially available FMLs are: (1) ‘Aramid Reinforced Aluminum Laminate’ (“ARALL”), based on aramid fibers; (2) ‘Glass Laminate Aluminum Reinforced Epoxy’ (“GLARE”), based on high strength glass fibers; and (3) ‘Carbon Reinforced Aluminum Laminate’ (“CARALL”), based on carbon fibers. In general, FMLs can offer a number of advantages relative to conventional engineering materials including: reduced fatigue crack growth rate; high strength to weight ratio; high stiffness to weight ratio; and fire resistance. Because of these and other advantageous materials properties, FMLs have been fruitfully implemented in a number of practical applications, including aerospace applications.

### SUMMARY OF THE INVENTION

Systems and methods in accordance with embodiments of the invention implement robust metallic glass-based fiber metal laminates. In one embodiment, a robust metallic glass-based fiber metal laminate includes: a first layer including a fiber-reinforced composite material; and a second layer including a metallic glass-based material; where the metallic glass-based material is based on at least one non-ferromagnetic element.

In another embodiment, at least one non-ferromagnetic element is one of: aluminum, titanium, copper, and zirconium.

In yet another embodiment, the fiber-reinforced composite material includes one of: carbon fibers, aramid fibers, glass fibers, Kevlar, Nextel cloth, and mixtures thereof.

In still another embodiment, the fiber reinforced composite material is one of: a carbon fiber epoxy composite; a glass fiber epoxy composite; and an aramid fiber/epoxy composite.

In still yet another embodiment, the metallic glass-based material has a thickness of between approximately 10 μm and approximately 100 μm.

In a further embodiment, the metallic glass-based material has a thickness of between approximately 0.1 mm and 1 mm.

In a yet further embodiment, the robust metallic glass-based material has a thickness of between approximately 1 mm and approximately 20 mm.

In a still further embodiment, a robust metallic glass-based fiber metal laminate further includes a third layer, itself including a polymeric material configured for radiation shielding.

In a still yet further embodiment, a robust metallic glass-based fiber metal laminate further includes a third layer, itself including a soft material configured for ballistic shielding.

In another embodiment, the first layer is an outermost layer of the robust metallic glass-based fiber metal laminate.

In yet another embodiment, the second layer is an outermost layer of the robust metallic glass-based fiber metal laminate.

In still another embodiment, a robust metallic glass-based fiber metal laminate further includes a third layer, itself including a fiber reinforced composite material, where: the constituent fibers within the fiber reinforced composite material of the first layer are generally oriented in a first direction; the constituent fibers within the fiber reinforced composite material of the third layer are generally oriented in a second direction; and the first direction is different than the second direction.

In still yet another embodiment, the first direction is substantially orthogonal to the second direction.

In a further embodiment, a robust metallic glass-based fiber metal laminate further includes a third layer, itself including a metallic glass-based material, where: each of the second layer and third layer includes panels of metallic glass-based material, and the panels within the second layer have a different orientation relative to the panels within the third layer.

In a still further embodiment, the panels within the second layer are substantially orthogonal to the panels within the third layer.

In a yet further embodiment, a robust metallic glass-based fiber metal laminate further includes a third layer, itself including a metallic glass-based material, where: the metallic glass-based material in the third layer is based on at least one non-ferromagnetic element that is different than that of the metallic glass-based material in the first layer.

In a still yet further embodiment, a robust metallic glass-based fiber metal laminate further includes a third layer, itself including a conventional metal.

In another embodiment, the first layer and the second layer are adjacently disposed.

In still another embodiment, the metallic glass-based material is one of: Zr_{41.2}Ti_{13.8}Cu_{12.5}Ni₁₀Be_{22.5}; Zr_{36.6}Ti_{31.4}Nb₇Cu_{5.9}Be_{19.1}; and Ti₄₈Zr₂₀V₁₂Cu₅Be₁₅.

In yet another embodiment, each of the first layer and the second layer are non-planar.

In still yet another embodiment, the first layer including a fiber-reinforced composite material is defined by the presence of the fiber-reinforced composite material; and the second layer including a metallic glass-based material is defined by the presence of the metallic glass-based material.

### BRIEF DESCRIPTION OF THE DRAWINGS

FIGS. 1A-1D illustrate prior art fiber metal laminate structures.

FIG. 2 illustrates a Whipple shield made from iron-based metallic glass-based ribbons in conjunction with crystalline aluminum.

FIG. 3 illustrates a robust metallic-glass based fiber metal laminate in accordance with certain embodiments of the invention

FIG. 4A illustrates a robust metallic-glass based fiber metal laminate that includes 9 metallic glass-based layers in conjunction with layers including carbon fiber in accordance with certain embodiments of the invention.

FIG. 4B illustrates a robust metallic-glass based fiber metal laminate that includes 25 metallic glass-based layers in conjunction with layers including carbon fiber in accordance with certain embodiments of the invention.

FIG. 5 illustrates a cross-sectional view of a carbon fiber/metallic glass-based fiber metal laminate that includes a cross-ply structure in accordance with certain embodiments of the invention.

FIG. 6A illustrates a robust metallic glass-based fiber metal laminate having an exposed metallic glass layer in accordance with certain embodiments of the invention.

FIG. 6B illustrates a robust metallic glass-based fiber metal laminate having an exposed fiber reinforced composite layer in accordance with certain embodiments of the invention.

FIGS. 7A-7B illustrate a robust metallic glass-based FML incorporating panels of ribbons of metallic glass-based materials having alternating orientations in accordance with certain embodiments of the invention.

FIG. 8 illustrates a robust metallic glass-based fiber metal laminate configured to be implemented as a panel on an aerospace vehicle in accordance with certain embodiments of the invention.

FIG. 9A illustrates a sensor that can be embedded within a robust metallic glass-based material in accordance with certain embodiments of the invention.

FIG. 9B illustrates circuitry that can be embedded within a robust metallic glass-based material in accordance with certain embodiments of the invention.

### DETAILED DESCRIPTION

Turning now to the drawings, systems and methods for robust metallic glass-based fiber metal laminates are illustrated. In numerous embodiments, a robust metallic glass-based fiber metal laminate includes a layer including a non-ferromagnetic metallic glass-based material and a layer including a fiber reinforced composite. In many embodiments, the metallic glass-based material is one of: a metallic glass-based material that is based on aluminum, a metallic glass-based material that is based on titanium, a metallic glass-based material that is based on copper, and a metallic glass-based material that is based on zirconium. In a number of embodiments, the fiber reinforced composite a carbon fiber/epoxy composite.

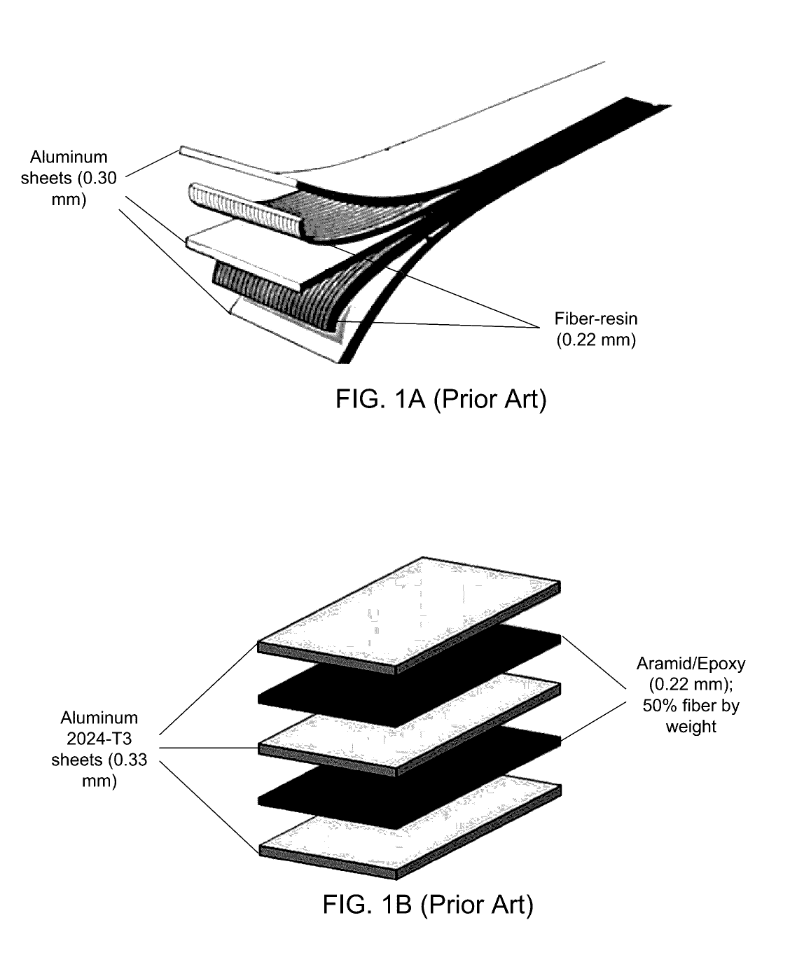

A conventional fiber metal laminate (“FML”) typically includes interlaced layers of fiber-reinforced composite materials and metal. For example, FIG. 1A depicts a prior art FML structure that includes interlaced layers of aluminum and fiber resin. In particular, FIG. 1A illustrates an exploded view of the FML highlighting its constituent components. More specifically, the illustrated prior art FML includes alternating layers of aluminum (each aluminum layer having a thickness of 0.3 mm) and fiber-resin (each fiber-resin layer having a thickness of 0.22 mm). The underlying image in FIG. 1A was obtained from H. F. Wu, et al., J. of Materials Science, 29, 4583 (1994), the disclosure of which is hereby incorporated by reference in its entirety, particularly as it pertains to FML structures. In general, the constituent layers of FMLs have complementary characteristics, and when they are aggregated (e.g. in an FML structure), the resulting structure can harness the advantageous aspects of the different constituent layers, as well as the synergy between them.

Certain FML structures have proved to be particularly advantageous, and have become widely commercially available. For instance, aluminum reinforced aramid laminates (“ARALL”) has become relatively popular. FIG. 1B illustrates an exploded view of an ARALL structure. In particular, the illustrated ARALL structure includes alternating layers of Aluminum 2024-T3 (each having a thickness of 0.33 mm) and aramid/epoxy composites, 50% fiber by weight (each having a thickness of 0.22 mm). Representative ARALL data is reproduced below in Table 1:

TABLE 1
Typical ARALL Material Properties

| | | Metal | Fiber | Fiber | |
|---|---|---|---|---|---|
| | Metal | Thickness | Layer | Direction | |
| | Type | (mm) | (mm) | (°) | Characteristics |
| ARALL 1 | 7075-T6 | 0.3 | 0.22 | 0/0 | fatigue, |
| | | | | | strength |
| ARALL 2 | 2024-T3 | 0.3 | 0.22 | 0/0 | fatigue, |
| | | | | | formability |
| ARALL 3 | 7475-T76 | 0.3 | 0.22 | 0/0 | fatigue, |
| | | | | | strength, |
| | | | | | exfoliation |
| ARALL 4 | 2024-T8 | 0.3 | 0.22 | 0/0 | fatigue, |
| | | | | | elevated |
| | | | | | temperature |

The underlying illustration in FIG. 1B and the data in Table 1 were obtained from T. Sinmazcelik et al., Materials and Design, 32, 3671 (2011), the disclosure of which is hereby incorporated in its entirety, particularly as it regards ARALL, GLARE, and CARALL FML structures.

FIG. 1C illustrates an exploded view of a glass laminate aluminum reinforced epoxy (“GLARE”), which has also become fairly widespread. In particular, FIG. 1C illustrates that a GLARE structure typically includes alternating layers of aluminum sheets and glass/epoxy composites. Note that in the illustration, it is depicted that cross-plied glass epoxy composites—i.e. where the orientation of the constituent fibers are orthogonal to each other—are implemented. As can be appreciated, the cross-plied composites can allow the GLARE to have material properties that are relatively uniform along two orthogonal axes. Representative GLARE data is reproduced below in Table 2.

TABLE 2
Typical GLARE Material Properties

| | | | Metal | Fiber | | |
|---|---|---|---|---|---|---|
| | | Metal Type | Thickness | Layer | Prepreg Orientation in | |
| Grade | Sub | (mm) | (mm) | (mm) | each Fiber Layer (°) | Characteristics |
| GLARE 1 | | 7475-T761 | 0.3-0.4 | 0.266 | 0/0 | Fatigue, strength, yield stress |
| GLARE 2 | GLARE 2A | 2024-T3 | 0.2-0.5 | 0.266 | 0/0 | Fatigue, strength |
| | GLARE 2B | 2024-T3 | 0.2-0.5 | 0.266 | 90/90 | Fatigue, strength |
| GLARE 3 | | 2024-T3 | 0.2-0.5 | 0.266 | 0/90 | Fatigue, impact |
| GLARE 4 | GLARE 4A | 2024-T3 | 0.2-0.5 | 0.266 | 0/90/0 | Fatigue, strength in 0° direction |
| | GLARE 4B | 2024-T3 | 0.2-0.5 | 0.266 | 90/0/90 | Fatigue, strength in 90° direction |
| GLARE 5 | | 2024-T3 | 0.2-0.5 | 0.266 | 0/90/90/0 | Impact, Shear, off-axis properties |
| GLARE 6 | GLARE 6A | 2024-T3 | 0.2-0.5 | 0.266 | +45/−45 | Shear, off-axis properties |
| | GLARE 6B | 2024-T3 | 0.2-0.5 | 0.266 | −45/+45 | Shear, off-axis properties |

The underlying illustration in FIG. 1C and the data in Table 2 were obtained from T. Sinmazcelik et al., Materials and Design, 32, 3671 (2011), which was incorporated by reference above.

Carbon reinforced aluminum laminate (“CARALL”) is yet another widely available FML. FIG. 1D illustrates an exploded view of a CARALL structure. In particular, FIG. 1D illustrates that a CARALL structure typically includes layers of aluminum sheets and at least one of a carbon fiber composite. In the illustration, the CARALL includes a carbon fiber/epoxy layer sandwiched by glass fiber epoxy composites. The underlying illustration in FIG. 1D and the data in Table 2 were obtained from T. Sinmazcelik et al., Materials and Design, 32, 3671 (2011), which was incorporated by reference above.

While conventional FMLs can offer a number of advantageous materials properties, they can be further developed by incorporating ‘metallic glasses,’ e.g. in lieu of, or in conjunction with, conventional metals. Metallic glasses, also known as amorphous alloys, embody a relatively new class of materials that is receiving much interest from the engineering and design communities. Metallic glasses are characterized by their disordered atomic-scale structure in spite of their metallic constituent elements—i.e. whereas conventional metallic materials typically possess a highly ordered atomic structure, metallic glass materials are characterized by their disordered atomic structure. Notably, metallic glasses typically possess a number of useful material properties that can allow them to be implemented as highly effective engineering materials. For example, metallic glasses are generally much harder than conventional metals, and are generally tougher than ceramic materials. They are also relatively corrosion resistant, and, unlike conventional glass, they can have good electrical conductivity. Importantly, the manufacture of metallic glass materials lends itself to relatively easy processing in certain respects. For example, the manufacture of a metallic glass can be compatible with an injection molding process.

Nonetheless, in the past, the manufacture of metallic glasses has presented challenges that limit their viability as engineering materials. In particular, metallic glasses are typically formed by raising a metallic alloy above its melting temperature, and rapidly cooling the melt to solidify it in a way such that its crystallization is avoided, thereby forming the metallic glass. The first metallic glasses required extraordinary cooling rates, e.g. on the order of 10⁶ K/s, and were thereby limited in the thickness with which they could be formed. Indeed, because of this limitation in thickness, metallic glasses were initially limited to applications that involved coatings. Since then, however, particular alloy compositions that are more resistant to crystallization have been developed, which can thereby form metallic glasses at much lower cooling rates, and can therefore be made to be much thicker (e.g. greater than 1 mm). These metallic glass compositions that can be made to be thicker are known as ‘bulk metallic glasses’ (“BMGs”).

In addition to the development of BMGs, ‘bulk metallic glass matrix composites’ (BMGMCs) have also been developed. BMGMCs are characterized in that they possess the amorphous structure of BMGs, but they also include crystalline phases of material within the matrix of amorphous structure. For example, the crystalline phases can exist in the form of dendrites. The crystalline phase inclusions can impart a host of favorable materials properties on the bulk material. For example, the crystalline phases can allow the material to have enhanced ductility, compared to where the material is entirely constituted of the amorphous structure. BMGs and BMGMCs can be referred to collectively as BMG-based materials. Similarly, metallic glasses, metallic glasses that include crystalline phase inclusions, BMGs, and BMGMCs can be referred to collectively as metallic glass-based materials or MG-based materials.

The potential of metallic glass-based materials continues to be explored, and developments continue to emerge. For example, in U.S. patent application Ser. No. 13/928,109, D. Hofmann et al. disclose the implementation of metallic glass-based materials in macroscale gears. The disclosure of U.S. patent application Ser. No. 13/928,109 is hereby incorporated by reference in its entirety, especially as it pertains to metallic glass-based materials, and their implementation in macroscale gears. Likewise, in U.S. patent application Ser. No. 13/942,932, D. Hofmann et al. disclose the implementation of metallic glass-based materials in macroscale compliant mechanisms. The disclosure of U.S. patent application Ser. No. 13/942,932 is hereby incorporated by reference in its entirety, especially as it pertains to metallic glass-based materials, and their implementation in macroscale compliant mechanisms. Moreover, in U.S. patent application Ser. No. 14/060,478, D. Hofmann et al. disclose techniques for depositing layers of metallic glass-based materials to form objects. The disclosure of U.S. patent application Ser. No. 14/060,478 is hereby incorporated by reference especially as it pertains to metallic glass-based materials, and techniques for depositing them to form objects. Furthermore, in U.S. patent application Ser. No. 14/163,936, D. Hofmann et al., disclose techniques for additively manufacturing objects so that they include metallic glass-based materials. The disclosure of U.S. patent application Ser. No. 14/163,936 is hereby incorporated by reference in its entirety, especially as it pertains to metallic glass-based materials, and additive manufacturing techniques for manufacturing objects so that they include metallic glass-based materials. Additionally, in U.S. patent application Ser. No. 14/177,608, D. Hofmann et al. disclose techniques for fabricating strain wave gears using metallic glass-based materials. The disclosure of U.S. patent application Ser. No. 14/177,608 is hereby incorporated by reference in its entirety, especially as it pertains to metallic glass-based materials, and their implementation in strain wave gears. Moreover, in U.S. patent application Ser. No. 14/178,098, D. Hofmann et al., disclose selectively developing equilibrium inclusions within an object constituted from a metallic glass-based material. The disclosure of U.S. patent application Ser. No. 14/178,098 is hereby incorporated by reference, especially as it pertains to metallic glass-based materials, and the tailored development of equilibrium inclusions within them. Furthermore, in U.S. patent application Ser. No. 14/252,585, D. Hofmann et al. disclose techniques for shaping sheet materials that include metallic glass-based materials. The disclosure of U.S. patent application Ser. No. 14/252,585 is hereby incorporated by reference in its entirety, especially as it pertains to metallic glass-based materials and techniques for shaping sheet materials that include metallic glass-based materials. Additionally, in U.S. patent application Ser. No. 14/259,608, D. Hofmann et al. disclose techniques for fabricating structures including metallic glass-based materials using ultrasonic welding. The disclosure of U.S. patent application Ser. No. 14/259,608 is hereby incorporated by reference in its entirety, especially as it pertains to metallic glass-based materials and techniques for fabricating structures including metallic glass-based materials using ultrasonic welding. Moreover, in U.S. patent application Ser. No. 14/491,618, D. Hofmann et al. disclose techniques for fabricating structures including metallic glass-based materials using low pressure casting. The disclosure of U.S. patent application Ser. No. 14/491,618 is hereby incorporated by reference in its entirety, especially as it pertains to metallic glass-based materials and techniques for fabricating structures including metallic glass-based materials using low pressure casting.

Notwithstanding all of these developments, the vast potential of metallic glass-based materials has yet to be fully appreciated. For instance, in general, non-ferromagnetic metallic glass-based ribbons (or foils) are not widely available, as their commercial viability is not yet fully appreciated. On the other hand, ferromagnetic metallic glass-based ribbons (or foils)—such as iron-based metallic glass-based ribbons (or foils)—are relatively widely available, as they are frequently used in the fabrication of transformers.

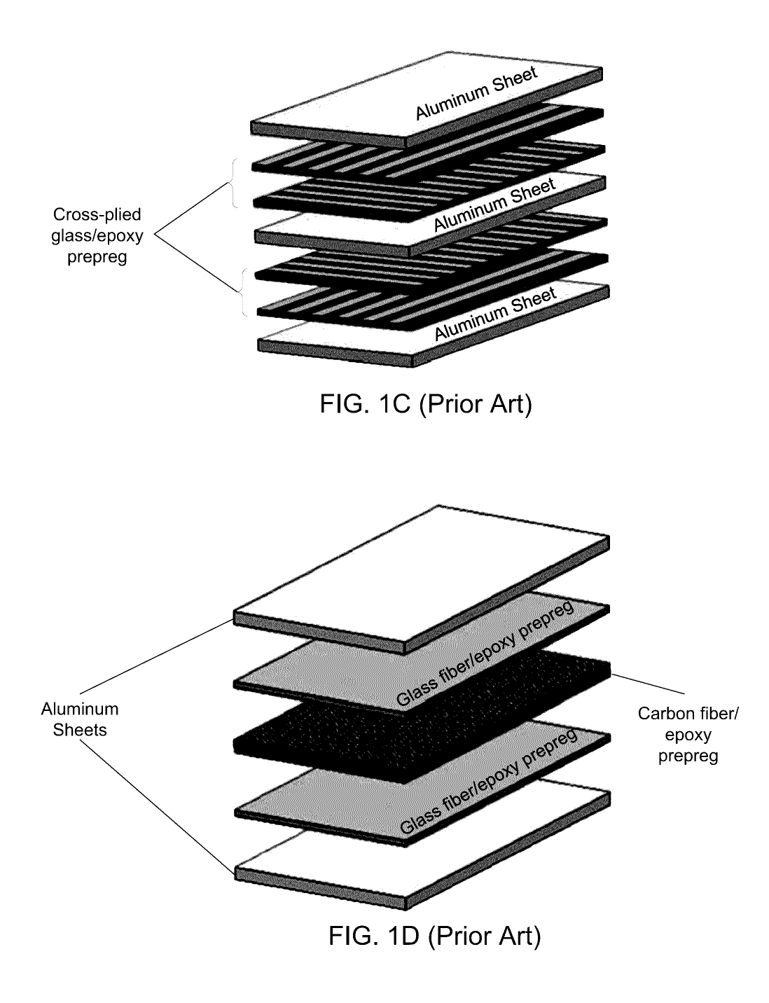

In some instances, iron-based metallic glass-based ribbons are aggregated with other materials to form particularly effective composites. For example, FIG. 2 illustrates a Whipple shield made from the aggregate of iron-based metallic glass-based ribbons and crystalline aluminum. In particular, the Whipple shield illustrated in FIG. 2 is meant to replicate that used on the International Space Station. The illustrated Whipple shield was subjected to hypervelocity impact tests, and the composite material prevented penetration of a 3 mm aluminum projectile traveling at 7 km/s.

Additionally, International Application No. PCT/US/2013/050555, applied for by The Nanosteel Company, Inc., discloses Fiber Metal Laminates that include the readily available iron-based metallic glass foils, which purportedly confer similar strength characteristics as conventional FMLs based on aluminum, but at a much reduced weight. The disclosure of International Application No. PCT/US/2013/050555 is hereby incorporated by reference in its entirety, especially as it pertains to FMLs that include iron-based glassy metal foils.

Although iron-based glassy metal foils may be readily available, the incorporation of iron-based glassy metal foils in conventional FML structures may present a number of issues. For instance, the iron-based glassy metal foils may be prone to delamination from the fiber-reinforced composite material. Additionally, exposed iron-based glassy metal foils may be prone to corrosion. Moreover, in many instances, it may be desirable to implement FMLs that do not have ferromagnetic components.

With this understanding, many embodiments of the invention incorporate metallic glass-based materials that are non-ferromagnetic within FML structures. In many embodiments, metallic glass-based materials that are based on one of aluminum, titanium, copper, and zirconium are incorporated into FML structures. Metallic glass-based materials that are based on these elements can better bond to fiber reinforced composites and can be more corrosion resistant relative to iron-based glassy metal foils. Additionally, metallic glass-based materials that are based on these elements can offer higher toughness and a lower density. Moreover, FMLs that incorporate non-ferromagnetic metallic glass-based materials can be advantageous in situations where non-ferromagnetism is desired. The structure of such robust metallic robust metallic glass-based fiber metal laminates is now discussed in greater detail below.

### Robust Metallic Glass-Based Fiber Metal Laminate Structure

In many embodiments of the invention, robust metallic glass-based fiber metal laminate structures that incorporate metallic glass-based materials based on non-ferromagnetic elements are implemented. In many embodiments, metallic glass-based materials that are based on one of aluminum, titanium, zirconium, and copper are incorporated within FMLs. In this context, the phrase “based on” can be understood to reference the element, or elements, that are present in the greatest amount (e.g. by atomic percent). For example, a metallic glass-based material that is ‘based on’ aluminum can refer to a composition where the element that is present in the greatest amount is aluminum. Metallic glass-based materials that are based on one of aluminum and titanium can lead to particularly effective FML structures.

In many embodiments, the incorporated metallic glass-based materials are based on: ZrCu, ZrTi, ZrTiBe, ZrTiCu, ZrTiCuBe, ZrTiCuNiBe, TiCu, ZrCuAl, and CuZr. As can be appreciated from the explanation above, a metallic glass-based material that is ‘based on’ ZrTiBe includes those elements (Zirconium, Titanium, and Beryllium) in greater proportion relative to any other included elements. It should of course be appreciated that the included metallic glass-based material can be based on any of a variety of non-ferromagnetic elements, including those listed above, and including those listed in prior-cited patent applications to D. Hofmann which were incorporated by reference above. Additionally, note that the metallic glass-based materials can be incorporated into FML structures in any of a variety of ways.

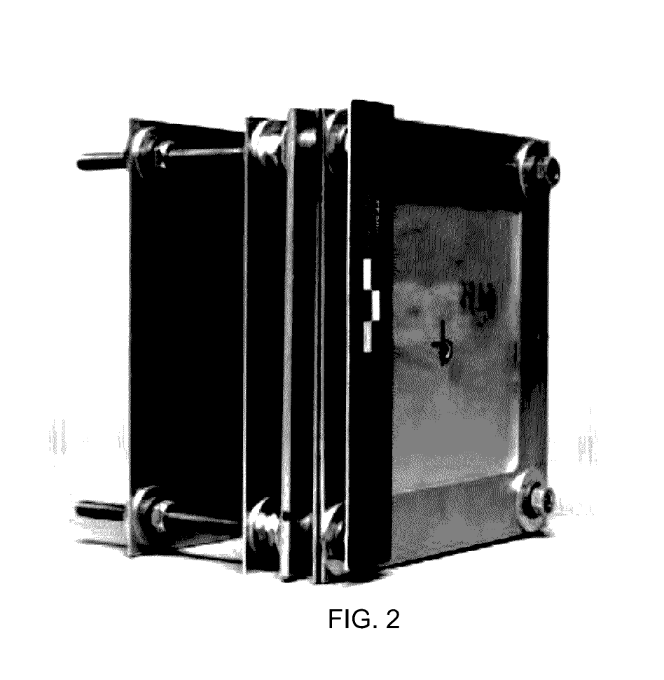

For example, FIG. 3 illustrates a robust metallic glass-based FML structure that adopts a conventional alternating arrangement in accordance with an embodiment of the invention. In particular, the FML structure 302 includes a first layer that includes a metallic glass-based material 302, immediately adjacent to a second layer that includes a fiber reinforced composite 303, which itself is immediately adjacent to a third layer that includes a metallic glass-based material 306, which itself is immediately adjacent to a fourth layer that includes a fiber reinforced composite 305, which itself is immediately adjacent to a fifth layer that includes a metallic glass-based material 308. The metallic glass-based materials that are included within first 304, third 306, and fifth 308 layers can be any suitable metallic glass-based material that is based on a non-ferromagnetic element. As mentioned above, in many embodiments the metallic glass-based material is based on one of aluminum, titanium, copper, and zirconium. For example, in some embodiments, incorporated metallic glass-based material is one of: Zr_{41.2}Ti_{13.8}Cu_{12.5}Ni₁₀Be_{22.5}; Zr_{36.6}Ti_{31.4}Nb₇Cu_{5.9}Be_{19.1}; and Ti₄₈Zr₂₀V₁₂Cu₅Be₁₅. Representative materials data for these alloys is presented in Table 3 below.

| | Max | | | |
|---|---|---|---|---|
| Metallic Glass | Thickness | Strength | Hardness | Density |
| Composition | (μm) | (GPa) | (V 50 g) | (g/cm³) |
| Zr_{41.2}Ti_{13.8}Cu_{12.5}Ni₁₀Be_{22.5} | 50000 | 2 | 540 | 6.0 |
| Zr_{36.6}Ti_{31.4}Nb₇Cu_{5.9}Be_{19.1} | 25000 | 1.5 | 440 | 5.8 |
| Ti₄₈Zr₂₀V₁₂Cu₅Be₁₅ | 40000 | 1.7 | 450 | 5.2 |

In many embodiments, at least two of the implemented layers including metallic glass-based materials have distinct metallic glass-based compositions. For example, in some embodiments, the first layer includes an aluminum-based metallic glass-based material, while the third layer includes a titanium-based metallic glass-based material. Metallic glass-based materials based on aluminum or titanium can offer relatively high corrosion resistance and relatively high specific strength. Note that while the illustrated embodiment depicts multiple layers including metallic glass-based materials, in many embodiments a robust metallic glass-based FML includes only one layer including a metallic glass based material. In a number of embodiments, the layer including a metallic glass-based material is used in conjunction with a layer including a conventional metal.

Importantly, the implemented layers can be of any suitable thickness. For example, in many embodiments, at least one layer including a metallic glass-based material has a thickness of between approximately 10 μm and approximately 100 μm. In a number of embodiments, at least one layer including a metallic glass-based material is characterized by a thickness between approximately 0.1 mm and approximately 1 mm. Although, it should be clear that the implemented layers including metallic glass-based material can conform to any thickness in accordance with embodiments of the invention. Similarly, any implemented fiber reinforced composite layers can have any suitable thickness in accordance with many embodiments of the invention. In a number of embodiments, the overall thickness of the robust metallic glass-based FML is between approximately 1 mm and approximately 20 mm.

Additionally, note that in some embodiments, robust metallic glass-based FML structures further include adjunct layers to provide additional functionality. For example, in some embodiments, a robust metallic glass-based FML includes a polymeric material for radiation shielding and/or a soft layer for ballistic shielding. But of course, as can be appreciated, robust metallic glass-based FML structures can be implemented in conjunction with any of a variety of adjunct layers in accordance with many embodiments of the invention.

Note that the implemented fiber reinforced composites can be any suitable fiber reinforced composite, including any of the above-listed conventional fiber reinforced composites. In many embodiments the included fiber reinforced composites include one of: a carbon fiber epoxy composite; a glass fiber epoxy composite; and an aramid fiber/epoxy composite. In many embodiments, the implemented fiber reinforced composites are based on: carbon fibers, aramid fibers, glass fibers, Kevlar, Nextel cloth, and mixtures thereof. Similarly, the matrix material can be any suitable material—e.g. any of a variety of epoxies and/or polymers—in accordance with many embodiments of the invention. In general, it should be clear that any suitable fiber reinforced composite can be implemented in accordance with embodiments of the invention. Additionally, as before with respect to layers including metallic glass-based material, each of a plurality of implemented layers including fiber reinforced composite materials can have distinct fiber reinforced composite materials in accordance with embodiments of the invention.

While layers including metallic glass-based materials have been discussed above, in many embodiments layer(s) including metallic glass-based materials are defined by the presence of the metallic glass-based material, and layer(s) including fiber reinforced composite materials are defined by the presence of the fiber reinforced composite material. In other words, a layer can be constituted entirely of a metallic glass-based material, and a layer can be constituted entirely of a fiber reinforced composite material in accordance with embodiments of the invention.

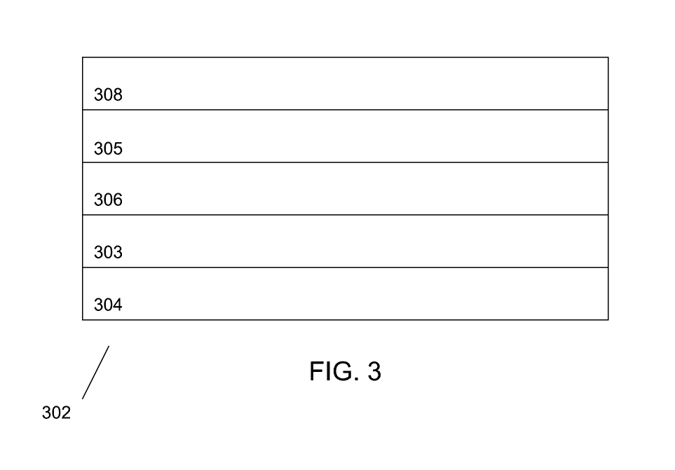

Additionally, note that while FIG. 3 depicts a 5 layer structure, robust metallic glass-based FML structures can include any number of layers in accordance with many embodiments of the invention. For example, FIG. 4A illustrates a robust metallic glass-based FML structure that includes 9 layers, each including a metallic glass-based material, in conjunction with fiber reinforced composites in accordance with an embodiment of the invention. FIG. 4B illustrates a robust metallic glass-based FML structure that includes 25 layers, each including a metallic glass-based material, in conjunction with fiber reinforced composites in accordance with an embodiment of the invention. In general, any number of layers can be incorporated into robust metallic glass-based FMLs in accordance with many embodiments of the invention.

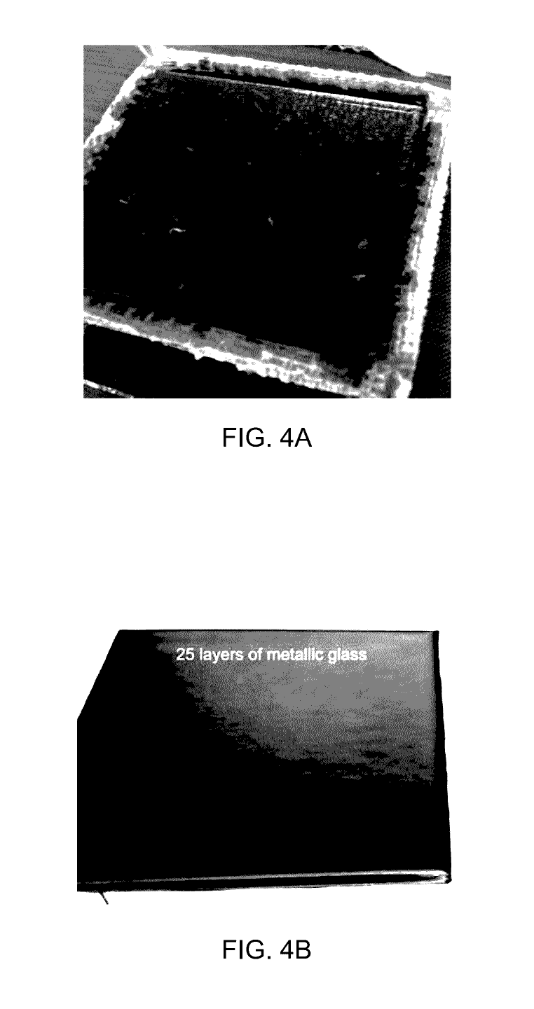

Moreover, it should be appreciated that robust metallic glass-based FMLs can incorporate cross-ply structures in accordance with many embodiments of the invention. For example, FIG. 5 illustrates a cross-section of a robust metallic glass-based FML that includes layers including metallic glass-based materials as well as cross-plied carbon fiber reinforced composites. In particular, the illustrated robust metallic glass-based FML 502 includes layers including metallic glass-based materials 504, between which a first carbon fiber reinforced composite layer 506 and a second carbon fiber reinforced composite layer 508 are disposed. The first carbon fiber reinforced composite layer 506 includes constituent carbon fibers that are generally oriented in a first direction; the second carbon fiber reinforced composite layer 508 includes constituent carbon fibers that are generally oriented in a second direction. The second direction and the first direction are generally orthogonal, and thus the cross-ply structure. As alluded above, the directionality of the fibers within the fiber reinforced composite layers influences the anisotropic materials properties of the respective layer. Accordingly, as can be appreciated, including a plurality of fiber reinforced composite layers, where each of the composite layers includes fibers oriented in a different direction, can confer the robust metallic glass-based FML with the respective materials properties in each of a plurality of directions. Note that while FIG. 5 illustrates the incorporation of fiber reinforced composite layers having fibers oriented in orthogonal directions, multiple fiber reinforced composite layers can have fibers oriented in any of a variety of direction relative to one another in accordance with many embodiments of the invention.

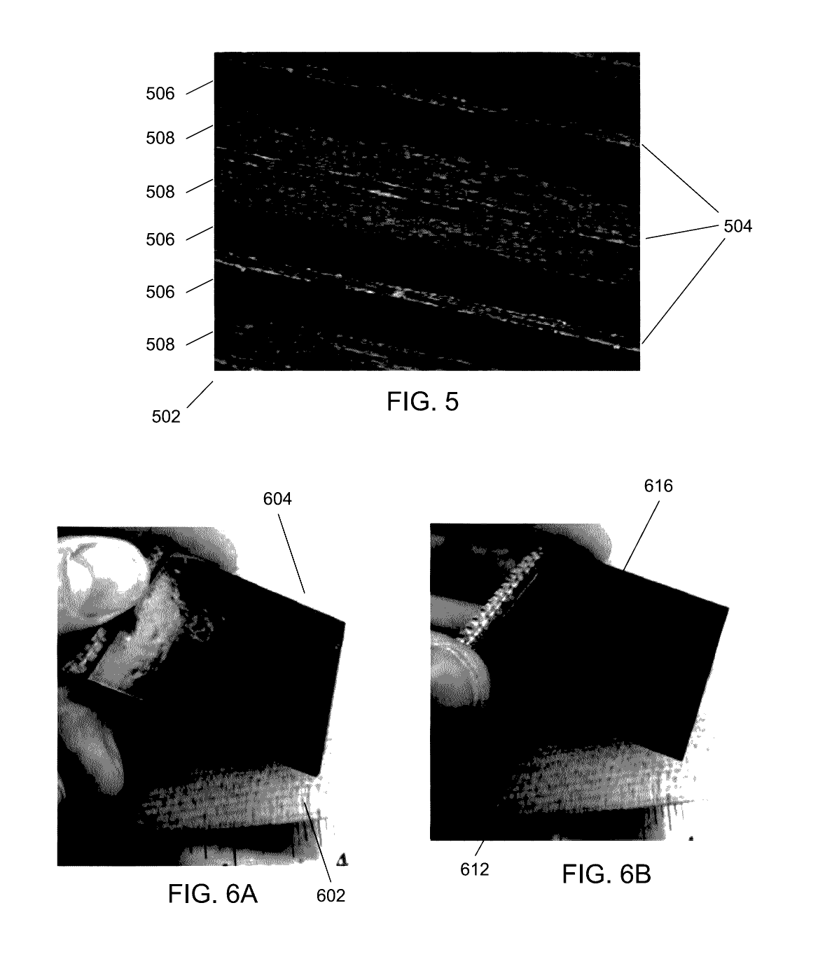

The outer exposed surface of robust metallic glass-based FMLs can be any suitable surface in accordance with embodiments of the invention. For example, in many embodiments, the outer exposed surface of the FML is the layer including the metallic glass-based material. This configuration may be advantageous when it is desirable that the exposed surface have a certain hardness value, for example. FIG. 6A illustrates a robust metallic-glass based FML 602 where the exposed layer 604 includes a metallic glass-based material. In several embodiments, the outer exposed surface of the FML includes a fiber reinforced composite. FIG. 6B illustrates a robust metallic-glass based FML 612 where the exposed layer 616 includes a fiber reinforced composite.

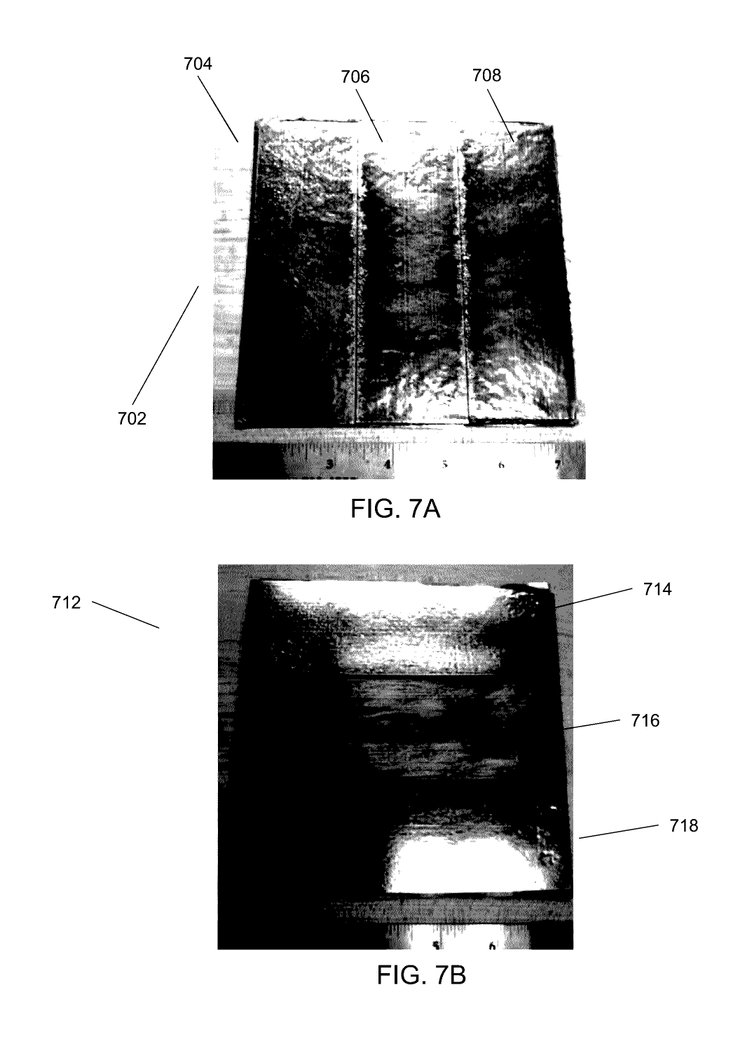

In many embodiments, robust metallic glass-based FMLs include layers that are panelized, where the panels are oriented differently (e.g. orthogonally) to one another. This ‘weave’ can help with mechanical integrity, e.g. providing mechanical strength in each of two orthogonal directions. For instance, FIGS. 7A and 7B illustrates a robust metallic glass-based FML including a layer comprising metallic glass that includes weaved panels of metallic glass-based material in accordance with certain embodiments of the invention. In particular, FIG. 7A illustrates a top metallic glass-based layer of a robust metallic glass-based FML in accordance with an embodiment of the invention. In particular, the top layer 702 includes three panels, 704, 706, and 708, each made from 2″ metallic glass-based ribbons. The three panels 704, 706, and 708 are vertically oriented. FIG. 7B illustrates the most proximate underlying layer including metallic glass-based material. In particular, the underlying layer 704 includes three panels, 714, 716, and 718, each made from 2″ metallic glass-based ribbons. Note that the three panels 714, 716, and 718 are horizontally oriented. As can be appreciated, this ‘weave’ can confer advantageous mechanical integrity. Although a particular arrangement has been illustrated, it should be clear that any of a variety of layering arrangements can be incorporated in accordance with embodiments of the invention. In some embodiments, each of the different panels of metallic glass-based material include different metallic glass-based materials.

In general, it is seen that robust metallic glass-based FMLs can be implemented in any of a variety of ways. As can be appreciated, the particularly implemented configuration can be based on the technical requirements of a specific application that the robust metallic glass-based FML is meant for. Accordingly, it should be clearly understood that embodiments of the invention are not limited to those embodiments illustrated in FIGS. 4-7. For example, while FIGS. 4-7 have depicted planar laminates, in some embodiments, the robust metallic glass-based fiber metal laminates are non-planar. For example, in some embodiments, they may conform to the non-planar geometry of the panel of a vehicle. Methods for manufacturing the described robust metallic glass-based FMLs are not discussed below.

### Methods for Manufacturing Robust Metallic Glass-Based FMLs

As can be appreciated, the above-described robust metallic glass-based FMLs can be manufactured in any of a variety of ways in accordance with embodiments of the invention. For instance, any of a variety of conventional fabrication techniques can be used to fabricate the FML structure. For example, where layers including metallic glass-based ribbons that have thicknesses between approximately 10 μm and approximately 100 μm are to be implemented, the metallic glass-based ribbons can be formed by melt spinning. Melt spinning typically involves applying slight quantities of molten metal to a rapidly spinning wheel which applies a high cooling rate to the melt and thereby solidifies it. Melt spinning typically produced ribbons of material. The ribbons can then be cut based on the desired geometry for implementation within a robust metallic glass-based FML. The metallic glass-based ribbons can be integrated into a robust metallic glass-based FML in any of a variety of ways, including, but not limited to: as a single sheet, by weaving, by stacking, and by overlaying. Where the layers including metallic glass-based materials are in the form of thicker sheets—e.g. having thickness of between approximately 0.1 mm to approximately 1 mm—the metallic glass sheets can be formed by twin-roll casting, for example. In some embodiments, the techniques described in U.S. patent application Ser. No. 14/163,936, incorporated by reference above, for forming sheet metal that includes metallic glass-based material using techniques akin to additive manufacturing are implemented. The incorporation by reference of U.S. patent application Ser. No. 14/163,936 is being re-alleged here, particularly as far as U.S. patent application Ser. No. 14/163,936 discloses fabricating sheet metals that include metallic glass-based materials. Of course, any of a variety of techniques can be used to form sheets of metallic glass-based material for integration within a robust metallic glass-based FML in accordance with embodiments of the invention. More generally, any of a variety of techniques can be used to form the metallic glass-based material for implementation within a robust metallic glass-based material in accordance with embodiments of the invention.

Similarly, any of a variety of techniques can be used to form the fiber reinforced composites for implementation within a robust-metallic glass-based FML. For example, as can be appreciated, ‘prepregs’ can be used in the fabrication of the described FMLs. Prepregs generally refer to the pre-impregnated fibers, e.g. with epoxy. The Prepregs are only partially cured and may still be pliable; they are usually layered with the layers including metallic glass-based material prior to a final bonding sequence.

As can be appreciated, any suitable methodology can be used to bond the layers within the FML. For example, in many embodiments, the layers of the FML are assembled and an autoclave is used to laminate the layers of the FML. In several embodiments, the layers of the FML are stacked, and then laminated in a vacuum bag. The polymeric binder associated with the fiber reinforced composite may influence whether it is more viable to laminate the assembly using an autoclave or using a vacuum bag. Of course, it should be clear that any suitable technique can be used to laminate the layers of the FML.

In many embodiments, robust metallic glass-based FMLs are fabricated so that they do conform to a planar geometry. For example, in some embodiments, prior to final bonding, the constituent layers are layered against a mold that has a non-planar geometry; the assembly is then laminated—e.g. using an autoclave or a vacuum bag. In this way, a nonplanar robust metallic glass-based FML can be developed. This can be useful for example where the FML is being produced for a non-planar panel within a vehicle.

In many embodiments, where the robust metallic glass-based FMLs are intended to include panels of metallic glass-based material, the panels are layered in the desired final arrangement, and then exposed to the same lamination cycle—e.g. in an autoclave or in a vacuum bag. Of course, robust metallic glass-based FMLs having a plurality of panels can be fabricated in any of a variety of ways in accordance with embodiments of the invention. For example, in some embodiments, the individual panels within a layer are laminated individually, and are subsequently bonded together with the other layers.

While several manufacturing methodologies have been mentioned, it should be clear that the described robust metallic glass-based FMLs can be fabricated using any of a variety of techniques in accordance with embodiments of the invention.

Example applications for robust metallic glass-based FMLs are now presented below.

### Applications for Robust Metallic Glass-Based FML

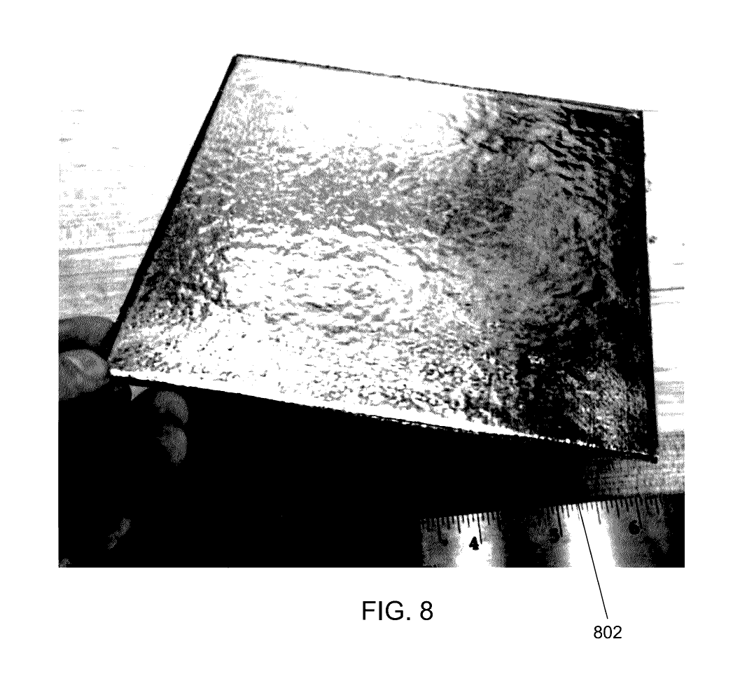

As can be appreciated, the described robust metallic glass-based FML structures are versatile and can be implemented in any of a variety of practical applications in accordance with embodiments of the invention. For example, in many embodiments, robust metallic glass-based FML structures are tailored for implementation in aerospace applications. Thus, for example, FIG. 8 illustrates a robust metallic glass-based FML that includes carbon fiber reinforced composites in conjunction with four layers including a metallic glass-based material formed from 8″ wide metallic glass-based ribbons; the illustrated robust metallic glass-based FML is particularly purposed for implementation as a bumper shield on the International Space Station. More specifically, the illustrated FML was designed so that it would have the same density as existing bumper shields being employed on the International Space Station.

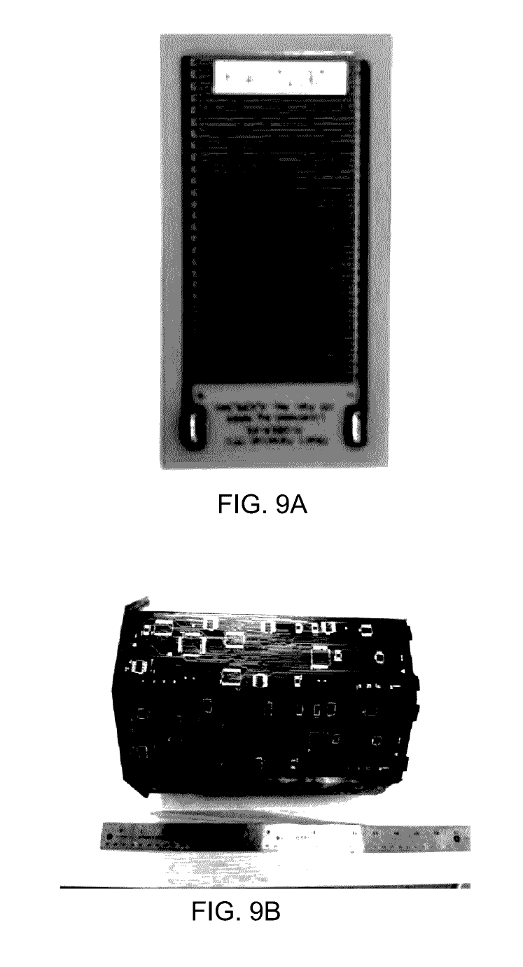

FIGS. 9A and 9B further regard practical applications for the described robust fiber metal laminates. In particular, FIG. 9A illustrates an embedded sensor that can be used in conjunction with a robust metallic glass-based FML in accordance with many embodiments of the invention. For example, the embedded sensor can be used to measure the real time stress/strain being experienced by the FML, and/or the overall integrity of the structure. Although, it should be clear that any suitable embedded sensor can be in conjunction robust metallic glass-based FMLs in accordance with embodiments of the invention, not just those for assessing the mechanical integrity of the structure.

FIG. 9B illustrates that robust metallic glass-based FML structures can also be used in conjunction with electronic circuitry in accordance with many embodiments of the invention. For example, the FML can serve as a particularly mechanically robust substrate.

In general, it can be seen that the described robust metallic glass-based FMLs are versatile and can be implemented in a variety of applications including, but not limited to, those described above. It is believed that the described robust metallic glass-based FMLs can be particularly effective in automobile, maritime, and aerospace applications, e.g. serving to form panels for vehicles in those industries.

More generally, as can be inferred from the above discussion, the above-mentioned concepts can be implemented in a variety of arrangements in accordance with embodiments of the invention. For example, any of a variety of non-ferromagnetic metallic glass-based materials can be implemented, and can be implemented with any of a variety of fiber reinforced composites. In many embodiments, the layers including the non-ferromagnetic metallic glass-based materials are implemented in conjunction with layers including conventional metals. The particular configuration implemented can be tailored to meet the desired application requirements. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What claimed is:

1. A robust metallic glass-based fiber metal laminate comprising:
a first layer comprising a fiber-reinforced composite material; and
a second layer comprising a metallic glass-based material;
wherein the metallic glass-based material is based on at least one non-ferromagnetic element.

2. The robust metallic glass-based fiber metal laminate of claim 1, wherein the at least one non-ferromagnetic element is one of: aluminum, titanium, copper, and zirconium.

3. The robust metallic glass-based fiber metal laminate of claim 2, wherein the fiber-reinforced composite material includes one of: carbon fibers, aramid fibers, glass fibers, Kevlar, Nextel cloth, and mixtures thereof.

4. The robust metallic glass-based fiber metal laminate of claim 3, wherein the fiber reinforced composite material is one of: a carbon fiber epoxy composite; a glass fiber epoxy composite; and an aramid fiber/epoxy composite.

5. The robust metallic glass-based fiber metal laminate of claim 3, wherein the metallic glass-based material has a thickness of between approximately 10 μm and approximately 100 μm.

6. The robust metallic glass-based fiber metal laminate of claim 3, wherein the metallic glass-based material has a thickness of between approximately 0.1 mm and 1 mm.

7. The robust metallic glass-based fiber metal laminate of claim 3, wherein the robust metallic glass-based material has a thickness of between approximately 1 mm and approximately 20 mm.

8. The robust metallic glass-based fiber metal laminate of claim 3, further comprising a third layer, itself comprising a polymeric material configured for radiation shielding.

9. The robust metallic glass-based fiber metal laminate of claim 3, further comprising a third layer, itself comprising a soft material configured for ballistic shielding.

10. The robust metallic glass-based fiber metal laminate of claim 3, wherein the first layer is an outermost layer of the robust metallic glass-based fiber metal laminate.

11. The robust metallic glass-based fiber metal laminate of claim 3, wherein the second layer is an outermost layer of the robust metallic glass-based fiber metal laminate.

12. The robust metallic glass-based fiber metal laminate of claim 3, further comprising a third layer, itself comprising a fiber reinforced composite material, wherein:
the constituent fibers within the fiber reinforced composite material of the first layer are generally oriented in a first direction;
the constituent fibers within the fiber reinforced composite material of the third layer are generally oriented in a second direction; and
the first direction is different than the second direction.

13. The robust metallic glass-based fiber metal laminate of claim 12, wherein the first direction is substantially orthogonal to the second direction.

14. The robust metallic glass-based fiber metal laminate of claim 3, further comprising a third layer, itself comprising a metallic glass-based material, wherein:
each of the second layer and third layer comprise panels of metallic glass-based material, and the panels within the second layer have a different orientation relative to the panels within the third layer.

15. The robust metallic glass-based fiber metal laminate of claim 14, wherein the panels within the second layer are substantially orthogonal to the panels within the third layer.

16. The robust metallic glass-based fiber metal laminate of claim 3, further comprising a third layer, itself comprising a metallic glass-based material, wherein:
the metallic glass-based material in the third layer is based on at least one non-ferromagnetic element that is different than that of the metallic glass-based material in the first layer.

17. The robust metallic glass-based fiber metal laminate of claim 3, further comprising a third layer, itself comprising a conventional metal.

18. The robust metallic glass-based fiber metal laminate of claim 3, wherein the metallic glass-based material is one of: Zr_{41.2}Ti_{13.8}Cu_{12.5}Ni₁₀Be_{22.5}; Zr_{36.6}Ti_{31.4}Nb₇Cu_{5.9}Be_{19.1}; and Ti₄₈Zr₂₀V₁₂Cu₅Be₁₅.

19. The robust metallic glass-based fiber metal laminate of claim 3, wherein each of the first layer and the second layer are non-planar.

20. The robust metallic glass-based fiber metal laminate of claim 1, wherein:
the first layer including a fiber-reinforced composite material is defined by the presence of the fiber-reinforced composite material; and
the second layer including a metallic glass-based material is defined by the presence of the metallic glass-based material.
